(19) United States
(12) Patent Application Publication
(10) Pub. No.: US 2023/0374415 A1
(43) Pub. Date: Nov. 23, 2023

(54) ANTI-GREYING COMPOSITION FOR LAUNDRY

(71) Applicant: BASF SE, Ludwigshafen am Rhein (DE)

(72) Inventors: Grit BAIER, Ludwigshafen (DE); Roland ETTL, Ludwigshafen (DE); Claudia ESPER, Ludwigshafen (DE); Antoine Maxime Charles Joseph BEZIAU, Ludwigshafen (DE); Juergen DETERING, Limburgerhof (DE); Oliver SPANGENBERG, Ludwigshafen (DE); Gabriele BOENEMANN, Ludwigshafen (DE)

(21) Appl. No.: 18/246,634

(22) PCT Filed: Sep. 17, 2021
(86) PCT No.: PCT/EP2021/075654

§ 371 Date: Mar. 24, 2023

(30) Foreign Application Priority Data
Sep. 28, 2020 (EP) 20198788.0

(51) Int. Cl. C11D 3/00; C11D 11/00; C11D 10/04; C11D 3/386; C11D 3/37; C11D 3/30

(52) U.S. Cl. CPC C11D 3/0036; C11D 11/0017; C11D 10/045; C11D 3/38645; C11D 3/3765; C11D 3/30; C11D 3/3723; C11D 1/22

(57) ABSTRACT

Described herein is a liquid composition including at least component (a) a polymer which is
(a1) an ethoxylated hexamethylene diamine polymer, quaternized and optionally sulfated including on average 20 to 30 ethoxylate groups (EO) with an average molecular weight Mw in a range from 2,000 to 10,000 g/mol and mixtures thereof, and/or
(a2) an ethoxylated polyethylenimine including on average 15 to 25 ethoxylate groups (EO) per NH-group with an average molecular weight M_{W} in a range from 5,000 to 20,000 g/mol;
   and
   component (b) at least one cellulase.

There is a continuous need in laundering to keep the removed soil in suspension during laundering, since once removed soil can redeposit on the surface of fabric and cause “greying”, which is especially noticeable on white textiles but which also affects appearance of colored textiles.

The term “laundering” relates to both household laundering and industrial laundering and means the process of treating textiles with a solution comprising a detergent formulation of the present invention. The laundering process usually is carried out by using technical devices such as a household or an industrial washing machine. Alternatively, the laundering process can be done by hand.

The term “textile” means any textile material including yarns (thread made of natural or synthetic fibers used for knitting or weaving), yarn intermediates, fibers, non-woven materials, natural materials, synthetic materials, as well as fabrics (a textile made by weaving, knitting or felting fibers) made of these materials such as garments (any article of clothing made of textile), cloths and other articles.

The term “fibers” includes natural fibers, synthetic fibers, and mixtures thereof. Examples of natural fibers are of plant (such as flax, jute and cotton) or animal origin, comprising proteins like collagen, keratin and fibroin (e.g. silk, sheeps wool, angora, mohair, cashmere). Examples for fibers of synthetic origin are polyurethane fibers such as Spandex® or Lycra®, polyester fibers, polyolefins such as elastofin, or polyamide fibers such as nylon. Fibers preferably include single fibers or parts of textiles such as knitwear, wovens, or nonwovens.

The term “redeposition” herein means deposition of dirt or color components that were removed from textiles during a laundering. The term “anti-redeposition” in this respect means the action to prevent or diminish the redeposition of dirt and color components on the textile.

The term “anti-greying” herein means the reduction and/or removal of “greying” from laundry.

By theory, cellulases achieve this “anti-greying effect” by hydrolyzing the cellulose chains in these areas at random positions with amorphous structure, leading to the removal of protruding fibers, removal of fibers with attached particles or higher accessibility for surfactants, and therefore showing a whitening or anti-greying effect. In addition, traces of cellulosic material in the washing liquor may be digested, preventing the adhesion of such fibers at the cotton surface of the garment. These effects, which are called anti-greying or anti-redeposition herein, can be evaluated using optical measurements. Suitable test methods are generally known in the art and are typically based on using artificial ballast soil systems with standard white test fabrics in repeated washing cycles in washing devices.

Providing an anti-greying solution was the object of the current invention.

The present invention provides a liquid composition comprising at least component (a) a polymer which is
(a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
(a2) an ethoxylated polyethylenimine with an average molecular weight M_{W} in the range from 3,000 to 250,000 (preferably 5,000 to 200,000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”),
   and
   component (b) a cellulase selected from endo-↑-1,4-glucanases according to EC 3.2.1.4 and endo-β-1,3-glucanases according to EC 3.2.1.39 (herein also referred to as “cellulase (b)” or “component (b)”).

In one embodiment, the liquid composition of the invention further comprises
component (c) a copolymer of with at least one monomer selected from unsaturated carboxylic acids, and at least one hydrophobic monomer.

The present invention also relates to a liquid laundry detergent comprising the liquid composition of the invention. Preferably, the liquid laundry detergent comprises at least
component (a) a polymer which is
   (a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
   (a2) an ethoxylated polyethylenimine with an average molecular weight M_{W} in the range from 3,000 to 250,000 (preferably 5,000 to 200,000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”),
      and
component (b) a cellulase selected from endo-β-1,4-glucanases according to EC 3.2.1.4 and endo-β-1,3-glucanases according to EC 3.2.1.39 (herein also referred to as “cellulase (b)” or “component (b)”).

In one embodiment, the liquid composition of the invention further comprises
component (c) a copolymer of with at least one monomer selected from unsaturated carboxylic acids, and at least one hydrophobic monomer (hereinafter also referred to as “polymer (c)” or “component (c)”).

The present invention also relates to a method of improving anti-greying ability of a cellulase (herein also referred to as “cellulase (b)” or “component (b)”) in laundry detergent, said method comprising the step of adding at least
component (a) a polymer which is
   (a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
   (a2) an ethoxylated polyethylenimine with an average molecular weight M_{W} in the range from 3,000 to 250,000 (preferably 5,000 to 200,000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”),
      and
component (b) a cellulase selected from endo-β-1,4-glucanases according to EC 3.2.1.4 and endo-β-1,3-glucanases according to EC 3.2.1.39 (herein also referred to as “cellulase (b)” or “component (b)”).

In one embodiment, the method of improving anti-greying ability of a cellulase further includes the step of adding component (c) as disclosed herein.

The present invention also relates to the use of a liquid laundry detergent for reducing and/or removing greying from textiles, wherein the detergent comprises at least
component (a) a polymer which is
   (a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
   (a2) an ethoxylated polyethylenimine with an average molecular weight M_{W} in the range from 3,000 to 250,000 (preferably 5,000 to 200,000 or 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”),
      and
component (b) a cellulase selected from endo-β-1,4-glucanases according to EC 3.2.1.4 and endo-β-1,3-glucanases according to EC 3.2.1.39 (herein also referred to as “cellulase (b)” or “component (b)”).

In one embodiment, the liquid laundry detergent used for reducing and/or removing greying from textiles further comprises component (c) as disclosed herein.

The present invention also relates to the method for reducing and/or removing greying from laundry, comprising contacting the laundry with a laundry detergent comprising at least
component (a) a polymer which is
   (a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
   (a2) an ethoxylated polyethylenimine with an average molecular weight M_{W} in the range from 3,000 to 250,000 (preferably 5,000 to 200,000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”),
      and
component (b) a cellulase selected from endo-β-1,4-glucanases according to EC 3.2.1.4 and endo-β-1,3-glucanases according to EC 3.2.1.39 (herein also referred to as “cellulase (b)” or “component (b)”).

In one embodiment, the method for reducing and/or removing greying from laundry, comprising contacting the laundry with a laundry detergent further comprising component (c) as disclosed herein.

The present invention also relates to a method of preparing a liquid composition as provided and defined herein, comprising mixing at least the following components in one or more steps in any order:
component (a) a polymer which is
   (a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
   (a2) an ethoxylated polyethylenimine with an average molecular weight M_{W} in the range from 3,000 to 250,000 (preferably 5,000 to 200,000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”), and
      and
component (b) a cellulase selected from endo-β-1,4-glucanases according to EC 3.2.1.4 and endo-β-1,3-glucanases according to EC 3.2.1.39 (herein also referred to as “cellulase (b)” or “component (b)”).

In one embodiment, the method of preparing a liquid composition comprising mixing at least components (a1) and/or (a2) and (b) and/or (c) in one or more steps in any order.

As used herein, the terms “stain(s)” or “soil” are used synonymously and comprise any kind of dirt on laundry.

As used herein, the term “laundry” comprises all kinds of textile and fabrics, and “laundry” or “laundry cleaning” particularly comprises home care laundry (fabrics, textile) as well as industrial and institutional (“I&I”) textile (fabrics) cleaning.

As used herein, the terms “comprise”, “comprising”, etc. are used interchangeably with “contain”, “containing”, etc. and are to be interpreted in a non-limiting, open manner. That is, e.g., further compounds may be present. However, such terms also encompass variations in the meaning of “consist of” or “consisting of”, etc., where the interpretation is of limiting nature and no further compounds are present, at least not in substantial or effective amounts.

The following descriptions and embodiments, particularly those of components (a), (b) and (c), apply mutatis mutandis to all methods, uses and compositions provided by the present invention.

### Component (a)

Component (a) comprises at least one polymer which is
(a1) a polymer which is an ethoxylated hexamethylene diamine, quaternized and optionally sulfated with an average molecular weight M_{W} in the range from 2,000 to 10,000 g/mol, more preferably 3,000-8,000, most preferably 4,000-6,000, and mixtures thereof (hereinafter also referred to as “polymer (a1)” or “component (a1)”); and/or
(a2) an ethoxylated polyethylenimine with an average molecular weight M_{W} in the range from 3,000 to 250,000 (preferably 5,000 to 200,000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (a2)” or “component (a2)”).

Component (a1) is preferably ethoxylated hexamethylene diamine, quaternized and optionally sulfated containing in average 10 to 40, preferably 15 to 30 and even more preferably 20 to 25 EO (ethoxylate) groups per —NH group, resulting in an average molecular weight M_{W} in the range from 2,000 to 8,000 g/mol, more preferably 3,000-6,000, most preferably 4,000-5,000. In one embodiment of the present invention, the ethoxylated hexamethylene diamine is quaternized and also sulfated, preferably bearing 2 cationic ammonium groups and 2 anionic sulfate groups.

Component (a2) is preferably ethoxylated polyethylenimine based on a polyethylene core and a polyethylene oxide shell. Suitable polyethylene imine core molecules are polyethylene imines with average molecular weight M_{W} in the range of 500 to 5000 g/mol. Preferred is a molecular weight from 500 to 1000 g/mol, even more preferred is an M_{W} of 600-800 g/mol. The ethoxylated polymer (a2) then has in average 5 to 50, preferably 10 to 30, more preferably 15 to 25 and even more preferably 18 to 22 EO (ethoxylate) groups per —NH group, resulting in an average molecular weight M_{W} in the range from 5,000 to 50,000 (preferably 8,000 to 20,000, more preferably 12,000 to 20,000, and most preferably 12,000 to 14,000) g/mol.

### Component (b)

In general, cellulases could be categorized into the following types: (i) endoglucanases (1,4-β-D glucan 4-glucohydrolase; EC 3.2.1.4) which cleave the glycosidic bond randomly, (ii) exoglucanases (β-1,4-D-glucan cellobiohydrolase; EC 3.2.1.91), which release cellobiose by splitting glycosidic bonds from the ends of the cellulose polymer, (iii) β-glucosidases (β-D-glucosideglucohydrolase; EC 3.2.1.21) catalyze the conversion of cellobiose to glucose and (iv) endo-β-1,3-glucanase enzyme (EC 3.2.1.39) which has activity for β-1,3 glucoside bonds.

Component (b) comprises at least one cellulase selected from endo-β-1,4-glucanases according to EC 3.2.1.4 and endo-β-1,3-glucanases according to EC 3.2.1.39.

Endo-β-1,4-glucanases usually hydrolyze randomly the internal β-1,4-glycosidic bonds in acid-swollen cellulose, carboxymethyl cellulose (CMC), cellulose azure and trinitrophenyl CMC resulting in rapid reduction of polymer length or degree of polymerization (DP) albeit with slow increase of the reducing sugar concentration.

In one embodiment, the liquid composition of the invention comprises at least one bacterial or fungal endo-β-1,4-glucanases according to EC 3.2.1.4. Preferably, at least one endo-β-1,4-glucanases comprised in the liquid composition of the invention lacks a carbohydrate binding domain (CBD). The endo-β-1,4-glucanases preferably has its pH optimum in the range of pH 5-11. More preferably, endo-β-1,4-glucanases according to the invention are not having a CBD (i.e. are lacking CBD).

In one embodiment, endo-β-1,4-glucanases lacking a CBD bind to amorphous cellulose preferably carboxymethylcellulose (CMC), preferably with a binding constant of above 2.0 per g cellulose, preferably of above 2.2 per g cellulose, more preferably of above 2.4 per g cellulose.

In one embodiment, at least one endo-β-1,4-glucanase is selected from endoglucanases I (EG-I), endoglucanases III (EG-III) and endoglucanases V (EG-V). Preferably, EG-I is selected from endoglucanases of glycosyl hydrolase family 7B. Preferably, EG-III is selected from endoglucanases of glycosyl hydrolase family 12A. Preferably, EG-V is selected from endoglucanases of glycosyl hydrolase family 45A.

In one embodiment, at least one endo-β-1,4-glucanase of glycosyl hydrolase family 7B is originating from a microorganism selected from Fusarium oxysporum, Humicola insolens and Trichoderma reesei. Preferably, at least one endo-β-1,4-glucanase of glycosyl hydrolase family 7B is originating from Humicola insolens.

In one embodiment, at least one endo-β-1,4-glucanase of glycosyl hydrolase family 12A is originating from a microorganism selected from Bacillus licheniformis and Trichoderma reesei.

In one embodiment, at least one endo-β-1,4-glucanase of glycosyl hydrolase family 45A is originating from a microorganism selected from Humicola insolens, Melanocarpus albomyces, Neurospora crassa and Phanerochaete chrysosporium. Preferably, at least one endo-β-1,4-glucanases of glycosyl hydrolase family 45A is originating from Melanocarpus albomyces.

In one embodiment, the liquid composition of the invention comprises at least one endo-β-1,3-glucanase enzyme usually having activity on one or more of pachyman, carboxymethyl curdlan, callose, schizophyllan and/or scleroglucan greater than or equal to the activity demonstrated by the equivalent amount of active protein according to SEQ ID NO: 7 of US 2020/0291333. Preferably the endo-β-1,3-glucanase enzyme herein will have activity on carboxymethyl curdlan for example P-CMCUR (available from Megazyme International, Bray, Ireland) and/or on barley β-glucan (for example P-BGBM from Megazyme International, Bray, Ireland) greater than or equal to the activity demonstrated by the equivalent amount of active protein according to SEQ ID NO: 7 of US 2020/0291333 (30 degrees C., pH 8.0 or pH of the cleaning composition).

In one embodiment, at least one endo-β-1,3-glucanases of glycosyl hydrolase family 16, 44 or 64, more preferably glycosyl hydrolase family 16.

In one embodiment, endo-β-1,3-glucanases originates from a microorganism selected from Paenibacillus sp, Zobellia galactanivorans or Thermotoga petrophila. Preferably, at least one endo-β-1,3-glucanase is selected from SEQ ID NO:1, SEQ ID NO:2, SEQ ID NO:3, SEQ ID NO:4, SEQ ID NO:5, SEQ ID NO:6 and SEQ ID NO:7—all sequences as disclosed in US 2020/0291333.

Since the presence of a carbohydrate domain (CBD) in a cellulase as disclosed herein may cause tensile strength loss of fabrics, the cellulase comprised in component (b) preferably does not have a CBD, i.e. lacks a CBD.

In a preferred embodiment, component (b) comprises endo-β-1,4-glucanase of glycosyl hydrolase family 7B originating from Humicola insolens DSM1800. More preferably, said endo-β-1,4-glucanase is at least 90% identical to the amino acid sequence according to positions 21-435 of SEQ ID NO:2 as disclosed in WO 2018/224544. At least one endo-β-1,4-glucanase comprised in component (b) is preferably is at least 91%, at least 92%, at least 93%, at least 94%, at least 95%, at least 96%, at least 97%, at least 98%, at least 99% or 100% identical to the amino acid sequence according to positions 21-435 SEQ ID NO:2 as disclosed in WO 2018/224544.

A cellulase having the amino acid sequence according to positions 21-435 SEQ ID NO:2 as disclosed in WO 2018/224544 is comprised in the enzyme product Celluclean® 5000L from Novozymes.

In one embodiment, the liquid composition comprises

component (a) a polymer which is
(a1) an ethoxylated hexamethylene diamine polymer, quaternized and sulfated containing in average 20 to 30 ethoxylate groups (EO) with an average molecular weight Mw in the range from 4,000 to 6,000 g/mol and mixtures thereof, and/or
(a2) an ethoxylated polyethylenimine containing in average 15 to 25 ethoxylate groups (EO) per NH-group with an average molecular weight M_{W} in the range from 12,000 to 14,000 g/mol;
   and

component (b) at least one cellulase, preferably selected from endo-β-1,4-glucanases, more preferably selected from endo-β-1,4-glucanases lacks a CBD.

For calculation of sequence identities, in a first step a sequence alignment has to be produced. According to this invention, a pairwise global alignment has to be produced using the algorithm of Needleman and Wunsch (J. Mol. Biol. (1979) 48, p. 443-453). Preferably, the program NEE-DLE (The European Molecular Biology Open Software Suite (EMBOSS)) is used for the purposes of the current invention, with using the programs default parameter (gap open=10.0, gap extend=0.5 and matrix=EBLOSUM62).

According to this invention, the following calculation of %-identity applies: %-identity=(identical residues/length of the alignment region which is showing the two aligned sequences over their complete length)*100. Thus, sequence identity in relation to comparison of two amino acid sequences is calculated by dividing the number of identical residues by the length of the alignment region which is showing the two aligned sequences over their complete length. This value is multiplied with 100 to give “%-identity”.

### Component (c)

Component (c) comprises at least one copolymer of with at least one monomer selected from unsaturated carboxylic acids, and at least one hydrophobic monomer.

Preferably, at least one monomer selected from unsaturated carboxylic acids is a compound of the general formula (PPC-I):

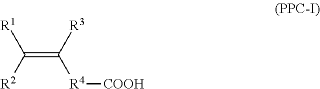

The variables in general formula (PPC-I) are defined as follows:

R¹, R² and R³ are independently selected from H; linear or branched C₁-C₁₂ alkyl, linear or branched C₂-C₁₂ alkenyl, wherein alkyl and/or alkenyl may be substituted with —NH₂, —OH, or —COOH; —COOH; and -COORS, wherein R⁵ is selected from linear or branched C₁-C₁₂ alkyl and linear or branched C₂-C₁₂ alkenyl.

R⁴ may be a spacer group, which is optionally selected from —(CH₂)ₙ— with n being in the range of 0 to 4, —COO—(CH₂)ₖ— with k being in the range of 1 to 6, —C(O)—NH— and —C(O)—NR⁶—, wherein R⁶ is selected from linear or branched C₁-C₂₂ alkyl, linear or branched C₂-C₂₂ alkenyl, and C₆-C₂₂ aryl.

Preferably, at least one monomer selected from unsaturated carboxylic acids according to formula (PCC-I) are selected from acrylic acid, methacrylic acid (MAA), 2-ethylacrylic acid, 2-phenylacrylic acid, malonic acid, crotonic acid, maleic acid (or maleic anhydride), fumaric acid, itaconic acid, aconitic acid, mesaconic acid, citraconic acid, sorbic acid, cinnamic acid, methylene malonic acid, unsaturated C₄-C₁₀ dicarboxylic acids, and mixtures thereof.

In one embodiment, at least one hydrophobic monomer is selected from isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Most preferably, the polymer is consisting of
i. maleic acid and
ii. at least one hydrophobic monomer selected from the group consisting of isobutene, diisobutene, butene, or mixtures thereof, preferably only diisobutene, and
   preferably wherein the polymer is partially or completely neutralized using suitable bases such as NaOH or KOH to form the alkali metal salts of such polymer.

In one embodiment, said polymer is characterized by having a K-value, i.e. the molecular weight determined according to Fikentscher's K-value, which is a value measured via the viscosity of the aqueous solution at a defined polymer content and defined viscosity measurement conditions and thus correlates to the molecular weight of the polymer for a given polymer class, is from 20 bis 80, preferably 25 bis 60, more preferably 30 bis 50 and even more preferably 35 bis 45, such as 40.

In one embodiment, the liquid composition comprises

component (a) a polymer which is
(a1) an ethoxylated hexamethylene diamine polymer, quaternized and sulfated containing in average 20 to 30 ethoxylate groups (EO) with an average molecular weight Mw in the range from 4,000 to 6,000 g/mol and mixtures thereof, and/or
(a2) an ethoxylated polyethylenimine containing in average 15 to 25 ethoxylate groups (EO) per NH-group with an average molecular weight M_{W} in the range from 12,000 to 14,000 g/mol;
   and

component (b) at least one cellulase, preferably selected from endo-β-1,4-glucanases, more preferably selected from endo-β-1,4-glucanases lacking CBD

and

component (c), which is a copolymer of
(i) maleic acid or maleic anhydride, and
(ii) at least one hydrophobic monomer selected from the group consisting of isobutene, diisobutene, butene, or mixtures thereof,
wherein the copolymer is partially or completely neutralized.

### Liquid Laundry Detergent

Liquid laundry compositions (i.e. liquid composition, liquid detergent formulations or liquid laundry formulations or liquid laundry detergents herein) comprising components (a), (b) and/or (c) as provided and to be employed in context with the present invention may further comprise additional components suitable for laundry detergents. Detergent components vary in type and/or amount in a detergent formulation depending on the desired application such as laundering white textiles, colored textiles, and wool. The component(s) chosen further depend on physical form of a detergent formulation (liquid, solid, gel, provided in pouches or as a tablet, etc). The component(s) chosen e.g. for laundering formulations further depend on regional conventions which themselves are related to aspects like washing temperatures used, mechanics of laundry machine (vertical vs. horizontal axis machines), water consumption per wash cycle etc. and geographical characteristics like average hardness of water.

Individual detergent components and usage in detergent formulations are known to those skilled in the art. Suitable detergent components comprise inter alia surfactants, builders, polymers, alkaline, bleaching systems, fluorescent whitening agents, suds suppressors and stabilizers, hydrotropes, and corrosion inhibitors. Further examples are described e.g. in “complete Technology Book on Detergents with Formulations (Detergent Cake, Dishwashing Detergents, Liquid & Paste Detergents, Enzyme Detergents, Cleaning Powder & Spray Dried Washing Powder)”, Engineers India Research Institute (EIRI), 6^{th} edition (2015). Another reference book for those skilled in the art may be “Detergent Formulations Encyclopedia”, Solverchem Publications, 2016.

It is understood that the detergent components are in addition to the components comprised in the liquid compositions of the invention. If a component comprised in the liquid compositions of the invention is also a detergent component, it might be the concentrations that need to be adjusted that the component is effective for the purpose desired in the detergent formulation.

Detergent components may have more than one function in the final application of a detergent formulation, therefore any detergent component mentioned in the context of a specific function herein, may also have another function in the final application of a detergent formulation. The function of a specific detergent component in the final application of a detergent formulation usually depends on its amount within the detergent formulation, i.e. the effective amount of a detergent component.

The term “effective amount” includes amounts of individual components to provide effective stain removal and/or effective cleaning conditions (e.g. pH, quantity of foaming), amounts of certain components to effectively provide optical benefits (e.g. optical brightening, dye transfer inhibition), and/or amounts of certain components to effectively aid the processing (maintain physical characteristics during processing, storage and use; e.g. viscosity modifiers, hydrotropes, desiccants).

In one embodiment, detergent formulations are formulations of more than two detergent components, wherein at least one component is effective in stain-removal, at least one component is effective in providing the optimal cleaning conditions, and at least one component is effective in maintaining the physical characteristics of the detergent.

In one embodiment, polymer (a1) is comprised in an amount of 0.2% to 5% by weight, preferably 0.3% to 4% by weight, 0.4% to 3% by weight, 0.5% to 2% by weight, or about 1% by weight, all relative to the total weight of the liquid laundry detergent. % values relate to 100% active material.

In one embodiment, polymer (a2) is comprised in an amount of 0.2% to 5% by weight, preferably 0.3% to 4% by weight, 0.4% to 3% by weight, 0.5% to 2% by weight, or about 1% by weight, all relative to the total weight of the liquid laundry detergent. % values relate to 100% active material.

In one embodiment, at least one cellulase comprised in component (b) is comprised in liquid laundry detergents in amounts of about 0.001% to 0.01%, preferably 0.002% to 0.009% by weight, more preferably 0.003% to 0.007% by weight all relative to the total weight of the liquid laundry detergent. % values relate to 100% active material.

In one embodiment, polymer (c) is comprised in an amount of 0.2% to 5% by weight, preferably 0.3% to 4% by weight, 0.4% to 3% by weight, 0.5% to 2% by weight, or about 1% by weight, all relative to the total weight of the liquid laundry detergents. % values relate to 100% active material.

Detergent formulations of the invention in one embodiment are provided as unit dose product enclosed in water-soluble polymeric films. Such containers are usually called pouches and can be of any form, shape and material which is suitable for holding a formulation, e.g., without allowing the release of said formulation from the pouch prior to water contact. The pouches may comprise a solid formulation and/or a liquid formulation in different compartments. The compartment for liquid components can be different in formulation than compartments containing solids (see e.g. EP 2014756).

In one embodiment, at least a part of the detergent formulation of the invention is provided as a liquid. Depending on whether a water-soluble package is enclosing the liquid detergent formulation, the liquid detergent formulation comprises water or is essentially free from water.

In one embodiment, liquid laundry detergents, preferably those comprised in a container made of water-soluble polymeric film, comprises 1,2-propane diol (MPG) in amounts up to 35% by weight, relative to the total weight of the detergent formulation. Preferably, the total weight of MPG in liquid laundry detergents is up to 30% by weight, up to 25% by weight, up to 20% by weight, up to 15% by weight, up to 10% by weight, up to 8% by weight, up to 7% by weight, or up to 6% by weight. The total amount of 1,2-propane diol in liquid detergent formulations preferably ranges from about 0.05% to 30% by weight, about 0.5% to 20% by weight, about 1% to 10% by weight, from about 2% to 8% by weight, from about 3% to 7% by weight, or from about 4% to 6% by weight, all relative to the total weight of the liquid detergent formulation.

Detergent formulations of the invention comprise at least one compound selected from surfactants, builders, polymers, fragrances and dyestuffs.

Detergent formulations of the invention comprise at least one surfactant selected from non-ionic surfactants, amphoteric surfactants, anionic surfactants, and cationic surfactants.

In one embodiment, detergent formulations of the invention comprise at least one non-ionic surfactant of the general formula (NIS-I):

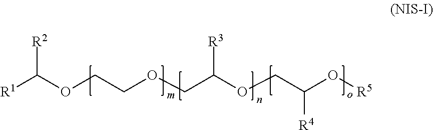

wherein in formula (NIS-I) the following applies:

R¹ is selected from C₁-C₂₃ alkyl and C₂-C₂₃ alkenyl, wherein alkyl and/or alkenyl are linear (straight-chain; n-) or branched; examples are n-C₇H₁₅, n-C₉H₁₉, n-C₁₁H₂₃, n-C₁₃H₂₇, n-C₁₇H₃₅, i-C₉H₁₉, i-C₁₂H₂₅.

R² is selected from H, C₁-C₂₀ alkyl and C₂-C₂₀ alkenyl, wherein alkyl and/or alkenyl are linear (straight-chain; n-) or branched.

R³ and R⁴, each independently selected from C₁-C₁₆ alkyl, wherein alkyl is linear (straight-chain; n-) or branched; examples are methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl.

R⁵ is selected from H and C₁-C₁₈ alkyl, wherein alkyl is linear (straight-chain; n-) or branched.

The integers of the general formula (NIS-I) are defined as follows:
m is in the range of zero to 200, preferably 1-80, more preferably 3-20; n and o, each independently in the range of zero to 100; n preferably is in the range of 1 to 10, more preferably 1 to 6; o preferably is in the range of 1 to 50, more preferably 4 to 25. The sum of m, n and o is at least one, preferably the sum of m, n and o is in the range of 5 to 100, more preferably in the range of from 9 to 50.

The non-ionic surfactants of the general formula (NIS-I) can be of any structure, is it block or random structure, and is not limited to the displayed sequence of formula (NIS-I).

In a preferred embodiment, detergent formulations comprise at least one non-ionic surfactant selected from compounds of general formula (NIS-I), wherein said non-ionic surfactant is characterized in R¹ being n-C₁₃H₂₇, R² and R⁵ being H, m being 3-20, n and o=0.

In a preferred embodiment, detergent formulations comprise at least one non-ionic surfactant selected from compounds of general formula (NIS-I), wherein said non-ionic surfactant is characterized in R¹ being linear or branched C₁₀ alkyl, R² and R⁵ being H, m being 3-14, n and o=0.

In a preferred embodiment, detergent formulations comprise at least two non-ionic surfactants, selected from compounds of general formula (NIS-I), wherein one of said non-ionic surfactants is characterized in R¹ being n-C₁₅H₃₁, R² and R⁵ being H, m being 11-80, n and o=0, and the other surfactant is characterized in R¹ being n-C₁₇ H₃₅, R² and R⁵ being H, m being 11-80, n and o=0.

In a preferred embodiment, detergent formulations comprise at least two non-ionic surfactants, selected from compounds of general formula (NIS-I), wherein one of said non-ionic surfactants s characterized in R¹ being n-C₁₂H₂₅, R² and R⁵ being H, m being 3-30, preferably 7, n and o=0, and the other surfactant is characterized in R¹ being n-C₁₄H₂₉, R² and R⁵ being H, m being 3-30, preferably 7, n and o=0.

In a preferred embodiment, detergent formulations comprise at least two non-ionic surfactants, selected from compounds of general formula (NIS-I), wherein one of said non-ionic surfactants is characterized in R¹ being n-C₁₁H₂₃, R² and R⁵ being H, m being 4-10, n and o=0, and the other surfactant is characterized in R¹ selected from n-C₁₁H₂₃ and n-C₁₇H₃₅, R² and R⁵ being H, m being 4-10, n and o=0.

In a preferred embodiment, detergent formulations comprise at least two non-ionic surfactants, selected from compounds of general formula (NIS-I), wherein one of said non-ionic surfactants is characterized in R¹ being n-C₉H₁₉, R² and R⁵ being H, m being 5-7, n and o=0, and the other surfactant is characterized in R¹ being n-C₁₇H₃₅, R² and R⁵ being H, m being 5-7, n and o=0.

In a preferred embodiment, detergent formulations comprise at least two non-ionic surfactants, selected from compounds of general formula (NIS-I), wherein one of said non-ionic surfactants is characterized in R¹ being n-C₁₁H₂₃, R⁵ being H, m is 7, n and o=0, and the other surfactant is characterized in R¹ being C₁₃H₂₇, R⁵ being H, m being 7, n and o=0.

In one embodiment, detergent formulations of the invention comprise at least one anionic surfactant of general formula (AS-I):

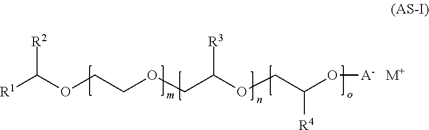

wherein in formula (AS-I) the following applies:

R¹ is selected from C₁-C₂₃-alkyl (such as 1-, 2-, 3-, 4-C₁-C₂₃-alkyl) and C₂-C₂₃-alkenyl, wherein alkyl and/or alkenyl are linear (straight-chain; n-) or branched, and wherein 2-, 3-, or 4-alkyl; examples are n-C₇H₁₅, n-C₉H₁₉, n-C₁₁H₂₃, n-C₁₃H₂₇, n-C₁₇H₃₅, i-C₉H₁₉,

R₂ is selected from H, C₁-C₂₀-alkyl and C₂-C₂₀-alkenyl, wherein alkyl and/or alkenyl are linear (straight-chain; n-) or branched.

R³ and R⁴, each independently selected from C₁-C₁₆-alkyl, wherein alkyl is linear (straight-chain; n-) or branched; examples are methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl.

A⁻ is selected from —RCOO⁻, —SO₃⁻ and RSO₃⁻, wherein R is selected from linear (straight-chain; n-) or branched C₁-C₈-alkyl, and C₁-C₄ hydroxyalkyl, wherein alkyl is. Compounds might be called (fatty) alcohol/alkyl (ethoxy/ether) sulfates [(F)A(E)S] when A⁻ is SO₃⁻, (fatty) alcohol/alkyl (ethoxy/ether) carboxylat [(F)A(E)C] when A⁻ is —RCOO⁻.

M⁺ is selected from H and salt forming cations. Salt forming cations usually are monovalent or multivalent; hence M⁺ equals 1/v M^{v+}. Examples include but are not limited to sodium, potassium, magnesium, calcium, ammonium, and the ammonium salt of mono-, di, and triethanolamine.

The integers of the general formula (AS-I) are defined as follows:

m is in the range of zero to 200, preferably 1-80, more preferably 3-20; n and o, each independently in the range of zero to 100; n preferably is in the range of 1 to 10, more preferably 1 to 6; o preferably is in the range of 1 to 50, more preferably 4 to 25. The sum of m, n and o is at least one, preferably the sum of m, n and o is in the range of 5 to 100, more preferably in the range of from 9 to 50.

Anionic surfactants of the general formula (AS-I) can be of any structure, block copolymers or random copolymers.

In a preferred embodiment, detergent formulations of the invention comprise at least one anionic surfactant according to formula (AS-I), wherein R¹ is n-C₁₁H₂₃, R² is H, A⁻ is SO₃⁻, m, n and o being 0. M⁺ preferably is NH₄⁺. Such compounds may be called ammonium lauryl sulfate (ALS) herein.

In a preferred embodiment, detergent formulations of the invention comprise at least one anionic surfactant according to formula (AS-I), wherein R¹ is n-C₁₁H₂₃, R² is selected from H, A⁻ is SO₃⁻, m being 2-5, preferably 3, and n and o being 0. M⁺ preferably is Nat Such compounds may be called laurylethersulfates (LES) herein, preferably sodium laurylethersulfates (SLES).

Detergent formulations, in one embodiment, comprise at least two anionic surfactants, selected from compounds of general formula (AS-I), wherein one of said anionic surfactants is characterized in R¹ being C₁₁, R² being H, m being 2, n and o=0, A⁻ being So₃⁻, M⁺ being Na⁺ and the other surfactant is characterized in R¹ being C₁₃, R² being H, m being 2, n and o=0, A⁻ being SO₃⁻, M⁺ being Na⁺.

In one embodiment, detergent formulations comprise at least one anionic surfactant selected from compounds of general formula (AS-II):

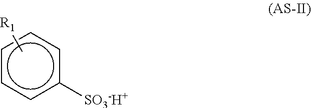

wherein R¹ in formula (AS-II) is C₁₀-C₁₃ alkyl. Detergent formulations of the invention, in one embodiment, comprise salts of compounds according to formula (AS-II), preferably sodium salts.

In a preferred embodiment, detergent formulations of the invention comprise at least two anionic surfactants, selected from compounds of general formula (AS-II), wherein one of said anionic surfactants is characterized in R¹ being C₁₀, and the other surfactant is characterized in R¹ being C₁₃. Compounds like this may be called LAS (linear alkylbenzene sulfonates) herein.

In one embodiment, detergent formulations comprising the components of the liquid compositions of the invention are liquid laundry detergents. Usually, laundry detergents comprise relatively high amounts of surfactants, preferably selected from at least one non-ionic surfactant according to formula (NIS-I), and/or at least one anionic surfactant according to formula (AS-I) and/or at least one anionic surfactant according to formula (AS-II).

In one embodiment, liquid laundry detergents of the invention comprise one or more complexing agents (chelating agents, sequestrating agents), precipitating agents, and/or ion exchange compounds, which usually form water-soluble complexes with calcium and magnesium. Such compounds may be called “builders” or “building agents” herein, without meaning to limit such compounds to this function in the final application of a detergent formulation.

Non-phosphate based builders according to the invention include sodium gluconate, citrate(s), silicate(s), carbonate(s), phosphonate(s), amino carboxylate(s), polycarboxylate(s), polysulfonate(s), and polyphosphonate(s).

In a preferred embodiment, detergent formulations of the invention comprise one or more citrates. The term “citrate(s)” includes the mono- and the dialkali metal salts and in particular the mono- and preferably the trisodium salt of citric acid, ammonium or substituted ammonium salts of citric acid as well as citric acid as such. Citrate can be used as the anhydrous compound or as the hydrate, for example as sodium citrate dihydrate. The citric acid, in one embodiment, is provided as a mixture with formate, e.g. Na-citrate:Na-formate=9:1.

In one embodiment, liquid laundry detergents comprise citric acid in amounts in the range of 0.1% to 10% by weight, in the range of 0.5% to 8% by weight, in the range of 1% to 5% by weight, or in the range of 2% to 4% by weight, all relative to the total weight of the detergent formulation; the citric acid in one embodiment is provided as a mixture with formate, e.g. Na-citrate:Na-formate=9:1.

In one embodiment, liquid laundry detergents comprise at least one aminocarboxylate selected from ethylenediaminetetraacetic acid (EDTA), diethylenetriaminepentaacetic acid (DTPA), methylglycine diacetate (MGDA), and glutamic acid diacetate (GLDA), all as disclosed above in amounts in the range of 1% to 10% by weight, in the range of 1.5% to 7% by weight, or in the range of 2% to 5% by weight all relative to the total weight of the liquid laundry detergent.

Detergent formulations of the invention, in one embodiment, comprise at least one phosphonate preferably selected from derivatives polyphosphonic acids such as of diphosphonic acid such as sodium salt of HEDP, derivatives of aminopolyphosphonic acid such as aminoalkylene phosphonic acids such as DTPMP.

In one embodiment, liquid laundry detergents comprise at least one phosphonate as disclosed herein, preferably selected from HEDP and DTPMP, in amounts in the range of 0.5% to 3.0% by weight, or in the range of 1.0% to 2.5% by weight, all relative to the total weight of the detergent formulation. In one embodiment, liquid laundry detergents do not comprise phosphonates.

In one embodiment of the present invention, formulations according to the invention are free from phosphates and polyphosphates, with hydrogenphosphates being subsumed, for example free from trisodiumphosphate, pentasodiumtripolyphosphate and hexasodiummetaphosphate. In connection with phosphates and polyphosphates, in the context of the present invention, “free from” is to be understood as meaning that the content of phosphate and polyphosphate is in total in the range from 10 ppm to 0.2% by weight, determined by gravimetry and relative to the total weight of the detergent formulation.

In one embodiment, liquid detergent formulations of the invention comprise at least one solvent according to formula (A):

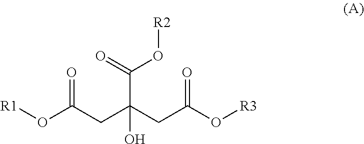

wherein the variables in formula (A) are defined as follows:

R1, R2, R3 are selected from H, linear C₁-C₈ alkyl, and branched C₃-C₅ alkyl, wherein at least one of R1, R2, and R3 is not H. Examples of linear C₁-C₈ alkyl are methyl, ethyl, n-propyl, n-butyl, n-pentyl, etc. Examples of branched C₃-C₈ alkyl are 2-propyl, 2-butyl, sec.-butyl, tert.-butyl, 2-pentyl, 3-pentyl, iso-pentyl, etc. Preferably, R1, R2, R3 are ethyl.

In one embodiment, the total weight of triethyl citrate in liquid detergent formulations is up to 3% by weight. Preferably, the total amount of triethyl citrate in the liquid detergent formulations ranges from about 0.0025% to 2.5% by weight. More preferably, the liquid detergent formulations comprise up to 1% by weight triethyl citrate. By weight means here relative to the total weight of the liquid detergent formulations.

In one embodiment, liquid laundry detergents of the invention comprise at least one additional enzyme, preferably selected from serine endopeptidase, triacylglycerol lipase, alpha-amylase and endo-1,4-β-mannosidase.

In one embodiment, liquid laundry detergents of the invention additionally comprise at least one serine endopeptidases (EC 3.4.21). Preferably, at least one serine endopeptidase is comprised in amounts of about 0.005% to 0.15% by weight, more preferably about 0.01% to 0.1% by weight, all relative to the total weight of the liquid laundry detergent. Preferably, at least one serine endopeptidase is a subtilisin type proteases (EC 3.4.21.62).

In one embodiment, at least one protease comprised in liquid laundry detergents of the invention is at least 80% identical to SEQ ID NO:22 as described in EP 1921147 and has proteolytic activity. In one embodiment, said protease is characterized by having at least amino acid glutamic acid (E) or aspartic acid (D) or asparagine (N) or glutamine (Q) or alanine (A) or glycine (G) or serine (S) at position 101 (according to BPN' numbering). Preferably, said protease comprises R101E, R101D or R101S.

In one embodiment, at least one protease comprised in liquid laundry detergents of the invention is at least 80% identical to SEQ ID NO:22 as described in EP 1921147 and has at least the mutations S3T+V4I+R101E+V205I or

### S3T+V4I+S9R+A15T+V68A+D99S+R101S+A103S+1104V+N218D or

R101E+S156D+L262E+optionally at least one further mutation selected from V104T, H120D, Q137H, S141 H, R145H and S163G,
all numberings according to the BPN′ numbering.

Liquid laundry detergent comprising at least one serine endopeptidase, preferably at least one subtilisin type protease may also comprise at least one protease stabilizer selected from phenylboronic acid derivative selected from 4-formyl phenyl boronic acid (4-FPBA, PSB1), 4-carboxy phenyl boronic acid (4-CPBA, PSB2), 4-(hydroxymethyl) phenyl boronic acid (4-HMPBA, PSB3) and p-tolylboronic acid (p-TBA, PSB4), with PSB1 being preferred.

Alternatively, at least one protease stabilizer may be selected from the group of peptide stabilizers according to formula (PA) or salts thereof or hydrosulfite adducts thereof:

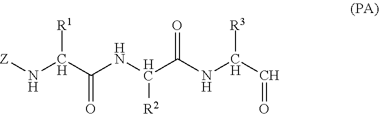

In one embodiment, R¹ and R² are groups such that NH—CHR¹—CO and/or NH—CHR²—CO are non-polar amino acids, preferably independently from each other selected from an L or D-amino acid residue of Ala, Val, Gly and Leu. R³ is a group such that NH—CHR³—CO is an L or D-amino acid residue of Tyr, Phe, Val, Ala or Leu. Such PSP may be called PSP1 herein.

In one embodiment, R¹ is a group such that NH—CHR¹—CO is an L or D-amino acid residue of Gly or Val, R² is a group such that NH—CHR²—CO is an L or D-amino acid residue of Ala, and R³ is a group such that NH—CHR³—CO is an L or D-amino acid residue of Tyr, Ala, or Leu.

In one embodiment, at least two selected from R¹, R² and R³ are groups such that NH—CHR¹—CO and/or NH—CHR²—CO and/or NH—CHR³—CO are non-polar amino acid residues, preferably independently from each other selected from an L or D-amino acid residue of Ala, Val, Gly and Leu.

In one embodiment, R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Leu.

Z in formula (PA) is preferably a N-terminal protection group selected from benzyloxycarbonyl (Cbz), p-methoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), or tert-butyloxycarbonyl (Boc). Preferably, Z is benzyloxycar bonyl (Cbz).

In one embodiment, liquid laundry detergents additionally comprise at least one triacylglycerol lipase (EC class 3.1.1.3), preferably in amounts of about 0.001% to 0.005%, more preferably 0.001% to 0.002% by weight, all relative to the total weight of the liquid laundry detergent. At least one lipase is preferably selected from fungal triacylglycerol lipase, preferably from Thermomyces lanuginosa lipase and variants thereof.

In one embodiment, liquid laundry detergents additionally comprise at least one alpha-amylase, preferably in amounts of about 0.001% to 0.015%, more preferably 0.002% to 0.015% by weight, all relative to the total weight of the liquid laundry detergent.

At least one alpha-amylase is preferably selected from those having an amino acid sequence according to SEQ ID NO:6, SEQ ID NO:7, SEQ ID NO:8, SEQ ID NO:9, SEQ ID NO:10, SEQ ID NO:11, SEQ ID NO:12, SEQ ID NO:13, SEQ ID NO:14, SEQ ID NO:15, SEQ ID NO:16, SEQ ID NO:17, SEQ ID NO:18, SEQ ID NO:19 and variants thereof—all as disclosed in WO 2018/224544. Preferably, at least one alpha-amylase is at least 95% identical to an amino acid sequence according to SEQ ID NO:6 preferably having deletions at positions D183 and G184 and more preferably having one or more substitutions selected from R118K, N195F, R320K and R458K.

In one embodiment, at least one alpha-amylase comprised in liquid laundry detergents of the invention is a hybrid amylase according to WO 2014/183920 with A and B domains having at least 90% identity to SEQ ID NO:2 of WO 2014/183920 and a C domain having at least 90% identity to SEQ ID NO:6 of WO 2014/183920; preferably the hybrid alpha-amylase is at least 95% identical to SEQ ID NO: 23 of WO 2014/183920.

In one embodiment, at least one alpha-amylase comprised in liquid laundry detergents of the invention is a hybrid amylase hybrid amylase according to WO 2014/183921 with A and B domains having at least 75% identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% identity to SEQ ID NO: 6 of WO 2014/183921; preferably, the hybrid alpha-amylase is at least 95% identical to SEQ ID NO: 30 as disclosed in WO 2014/183921.

In one embodiment, at least one alpha-amylase comprised in liquid laundry detergents of the invention is a hybrid amylase according to WO 2021/032881 comprising an A and B domain originating from the alpha amylase from Bacillus sp. A 7-7 (DSM 12368) and a C domain originating from the alpha amylase from Bacillus cereus wherein the hybrid amylase has amylolytic activity; preferably, the A and B domain are represented by SEQ ID NO: 42 and a C domain is represented by SEQ ID NO: 44—both sequences as disclosed in WO 2021/032881; more preferably, the hybrid amylase has a sequence according to SEQ ID NO: 54 as disclosed in WO 2021/032881.

In one embodiment, liquid laundry detergents additionally comprise at least one mannanase, preferably in amounts of about 0.0005% to 0.005%, more preferably 0.0005% to 0.002% by weight, all relative to the total weight of the detergent formulation. At least one mannanase is selected from endo-1,4-β-mannosidase (EC 3.2.1.78).

In one embodiment, at least one mannanase comprised in liquid laundry detergents of the invention is at least one mannanase comprised in the liquid compositions of the invention is selected from WO 2009/074685 and variants at least 90% identical thereto.

In one embodiment, at least one mannanase comprised in the liquid laundry detergents of the invention is selected from mannanases originating from Trichoderma organisms, such as disclosed in WO 93/24622 and WO 2008/009673.

In one embodiment, at least one mannanase comprised in the liquid laundry detergents of the invention is selected from mannanases having a sequence according to positions 31-490 of SEQ ID NO:388 of WO 2005/003319 and variants which are preferably at least 90% identical thereto.

In one embodiment of the present invention, liquid detergent formulations comprise one or more viscosity modifiers. Depending on the viscosity desired, liquid detergent formulations of the invention usually comprise one or more rheology modifiers, which are also known as thickeners in the art. In one embodiment, the detergent formulation of the invention comprises at least one naturally derived polymeric structurants, preferably selected from polysaccharide derivatives such as xanthan gum in amounts in the range of 0.1% to about 5% by weight, or even from about 0.2% to about 0.5% by weight, relative to the total weight of the detergent formulation.

In one embodiment, liquid detergent formulations of the invention are free from bleaches, for example free from inorganic peroxide compounds or chlorine bleaches such as sodium hypochlorite, meaning that liquid detergent formulations according to the invention comprise in total 0.8%, 0.5%, 0.1% or 0.01% by weight or less of inorganic peroxide compound and chlorine bleach, relative in each case on total weight of the liquid detergent formulation.

In one embodiment of the present invention, the laundry composition may have a pH value in the range of from 7.0 to 11.5, 7.5 to 11.5, 7.5 to 8.7, preferably 7.5 to 8.5, particularly within liquid laundry detergent compositions.

The temperatures during laundry washing may be higher (particularly for l&I purposes), i.e. 60° C. or more, or lower (particularly for home care laundry), i.e. 60° C. or less. For example, the temperature may be 15° C. to 60° C., 20° C. to 60° C., preferably 20° C. to 50° C., more preferably 20° C. to 40° C.

The combination of components (a), (b), and (c) as described and provided herein is generally effective for removing stains from cotton textiles such as, inter alia, wfk10A [standard cotton], wfk80A [cotton knitwear], wfk12A [cotton Terry cloth], EMPA 221 [cotton Cretone bleached], T-shirt according to EN/EC 60456. The combination of components (a), (b), and (c) as described and provided herein is generally effective for removing stains from synthetic textiles such as, inter alia, wfk30A [polyester], EMPA406 [polyamide]. The combination of components (a), (b), and (c) as described and provided herein is generally effective for removing stains from mixed textiles (cotton-synthetic mixture) such as wfk20A [PES/Co blend].

When determining the reduction and/or removal of greying from a certain fabric or textile, it is preferred that the effect is determined for cotton fabrics and/or synthetic fabrics and/or mixed cotton-synthetic fabrics as also shown in the examples. That is, in one embodiment of the present invention, the combination of components (a), (b), and/or (c) as described and provided herein is particularly effective in anti-greying.

### Further Specific Embodiments

1. A liquid composition comprising at least
component (a) a polymer which is
   (a1) an ethoxylated hexamethylene diamine polymer, quaternized and optionally sulfated containing in average 20 to 30 ethoxylate groups (EO) with an average molecular weight Mw in the range from 2,000 to 10,000 g/mol and mixtures thereof, and/or
   (a2) an ethoxylated polyethylenimine containing in average 15 to 25 ethoxylate groups (EO) per NH-group with an average molecular weight M_{W} in the range from 5,000 to 20,000 g/mol;
and
component (b) at least one cellulase.
   2. Liquid composition according to embodiment 1, wherein (a1) is an ethoxylated hexamethylene diamine polymer, quaternized and sulfated containing in average 20 to 30 ethoxylate groups (EO) with an average molecular weight Mw in the range from 5,000 to 6,000 g/mol and mixtures thereof
   3. Liquid composition according to embodiments 1 and 2, wherein (a2) is an ethoxylated polyethylenimine containing in average 15 to 25 ethoxylate groups (EO) per NH-group with an average molecular weight M_{W} in the range from 12,000 to 14,000 g/mol.
   4. Liquid composition according to any preceding embodiment, wherein at least one cellulase is selected from endo-β-1,4-glucanases according to EC 3.2.1.4 and endo-β-1,3-glucanases according to EC 3.2.1.39.
   5. Liquid composition according to any preceding embodiment, wherein at least one cellulase is an endo-β-1,4-glucanase which has no carbohydrate binding domain (CBD).
   6. Liquid composition according any preceding embodiment, further comprising component (c), which is a copolymer of
(i) maleic acid or maleic anhydride, and
(ii) at least one hydrophobic monomer selected from the group consisting of isobutene, diisobutene, butene, or mixtures thereof,
wherein the copolymer is partially or completely neutralized.
   7. Liquid composition according to embodiment 6, wherein the copolymer has a K-value of 35-45.
   8. Liquid composition according to any preceding embodiment, wherein the composition comprises at least one detergent component.
   9. Liquid composition according to embodiment 8, wherein the composition is a liquid laundry detergent.
   10. Use of the liquid compositions of embodiments 1-6 as an anti-greying additive for laundry detergents.
   11. Use of a laundry detergent according to embodiments 8 and 9 for reducing and/or removing greying from textiles.
   12. Use according to embodiment 11, wherein the textiles are selected from cotton and/or synthetic fabrics.
   13. A method of improving anti-greying ability of a cellulase (b) in laundry detergents, said method comprising the step of adding at least
component (a) a polymer which is
   (a1) an ethoxylated hexamethylene diamine polymer, quaternized and optionally sulfated containing in average 20 to 30 ethoxylate groups (EO) with an average molecular weight Mw in the range from 2,000 to 10,000 g/mol and mixtures thereof, and/or
   (a2) an ethoxylated polyethylenimine containing in average 15 to 25 ethoxylate groups (EO) per NH-group with an average molecular weight M_{W} in the range from 5,000 to 20,000 g/mol;
and optionally component (c) comprising at least one copolymer, wherein the copolymer is made of two types of monomers, one monomer selected from unsaturated carboxylic acids, and one hydrophobic monomer.

The present invention is further illustrated by the following examples, however, without being limited by the embodiments and specifications defined therein.

### EXAMPLES

### Liquid Compositions of the Invention Tested

| Conc in % by weight | LC-I | LC-II | LC-III | LC-IV | LC-V | LC-VI |
|---|---|---|---|---|---|---|
| Component (a1) | 0.5-2.0 | — | 0.5-2.0 | 0.5-2.0 | — | 0.5-2.0 |
| Component (a2) | — | 0.5-2.0 | 0.5-2.0 | — | 0.5-2.0 | 0.5-2.0 |
| Component (b) | 0.004-0.007 | 0.004-0.007 | 0.004-0.007 | 0.004-0.007 | 0.004-0.007 | 0.004-0.007 |
| Component (c) | — | — | — | 0.5-2.0 | 0.5-2.0 | 0.5-2.0 |

Component (a1): Ethoxylated hexamethylene diamine M_{W} ∞4,500, 24 EO/NH
Component (a2): Ethoxylated polyethylenimine M_{W} ˜12,000-14,000 (PEI core ˜600-800), 20 EO/NH
Component (b): Celluclean® 5000 L (Novozymes)
Component (c): copolymer of maleic acid and diisobutene with K-value of about 40
Concentrations in % by weight relate to 100% active matter

### Application Test in the Launder-O-Meter

The washing performance for the selected compositions was determined in the launder-O-meter (LP2 Typ, SDL Atlas Inc., USA) in beakers of 1L size under the following washing conditions.

| Washing liquor | 250 ml |
|---|---|
| Steel balls* | 20 pieces each having 6 mm diameter and 0.9 g) |
| Washing time/temperature | 30 min at 30° C. |
| Dosage [detergent] | 4 g/L ES1_C |
| Washing cycles | 3 |
| Water hardness | 2.5 mmol/L; Ca²⁺:Mg²⁺:HCO₃ = 4:1:8 |
| Test fabrics | ~15 g [type see below] |
| Soil donor swatches | ~2.5 g each [type see below] |
| Sum test fabrics + soil donor swatches | ~20 g-~25 g. |
| Soil swatches | 2 × 2.5 g [type see below] |
| Fabric/liquor ratio | ~1:10-~1:12.5 |

| ES1_C components | | % by weight |
|---|---|---|
| anionic surfactant | linear alkylbenzene sulfonate (S1) | 5.5 |
| soap | C₁₂-C₁₈ coco fatty acid | 2.4 |
| non-ionic surfactant | alkyl polyethyleneglycol ether (S2) | 5.4 |
| anionic surfactant | sodium laureth sulfate 2EO (S3) | 5.4 |
| 1,2-pentane diol | | 6.0 |
| C₂H₅OH | | 2.0 |
| Sodium citrate | | 3.0 |

components (a1), (a2), (b) and (c) individually or in combination as disclosed in
LC-I, LC-II, LC-III, LC-IV LC-V and LC-VI above; all comprised as indicated below

| | | |
|---|---|---|
| pH | Adjusted with NaOH | 8.5-8.7 |
| H₂O | up to 100% | |

S1: linear alkylbenzene sulfonate according to formula (AS-II), wherein one of said anionic surfactants is characterized in R¹ being C₁₀, and the other surfactant is characterized in R¹ being C₁₃.
S2: mixture of two non-ionic surfactants according to formula (NIS-I), wherein one of said non-ionic surfactants is characterized in R¹ being n-C₁₂H₂₅, R² and R⁵ being H, m being 7, n and o=0, and the other surfactant is characterized in R¹ being n-C₁₄H₂₉, R² and R⁵ being H, m being 7, n and o=0.
S3: mixture of two anionic surfactant according to formula (AS-I), wherein one of said anionic surfactants is characterized in R¹ being C₁₁, R² being H, m being 2, n and o=0, A⁻ being SO₃⁻, M⁺ being Na⁺ and the other surfactant is characterized in R¹ being C₁₃, R² being H, m being 2, n and o=0, A⁻ being SO₃⁻, M⁺ being Na⁺.
All ingredients % by weight relate to 100% active matter.
wfk test fabrics were purchased via wfk Testgewebe GmbH: 41379 Brüggen, Germany. SBL 2004 fabrics and wfk clay were also purchased via wfk Testgewebe GmbH.
EMPA test fabrics were purchased via Swissatest Testmaterialien AG: 9015 St. Gallen, Switzerland.
Tissues were either used as received or cut into pieces as needed. Test fabrics used (10 cm×10 cm squares):
Cotton: wfk10A [standard cotton], wfk80A [cotton knitwear], wfk12A [cotton Terry cloth], EMPA 221 [cotton Cretone bleached], T-shirt according to EN/EC 60456
Synthetics: wfk20A [PES/Co blend], wfk30A [polyester], EMPA406 [polyamide]

Soil was a mixture of:
1. EMPA-SBL: two 2.5 g EMPA 101 and two 2.5 g SBL 2004 fabrics
2. EMPA-SBL-clay: 2.5 g EMPA 101 and 2.5 g SBL 2004 fabrics and 1.25g wfk clay slurry

The wfk clay slurry was prepared by homogenizing 120 g of wfk clay and 450 g deionized water, followed by addition of 30 g of an oil mixture that consists of peanut oil (75 parts, e.g. Brändle) and mineral oil (25 parts, lubricating oil O-10-002) and subsequent homogenization.

The first cycle was run using the launder-O-meter beakers containing the test wash solution (0.25 L) plus test fabrics and ballast soil at 30° C. for 30 min (fabric to liquor ratio of ˜1:10 for EMPA-SBL; 1:12.5 for EMPA-SBL-clay). After the wash and rinsing, the test fabrics and ballast soil were separated. The process was repeated using the washed test fabrics and performing 3 cycles in total.

New soil was used for each cycle. After the 3 cycles, the test fabrics were rinsed in water, followed by drying at ambient room temperature overnight.

Rinse step: After washing the soiled swatches were removed from the vessel and placed in a 10 liter bucket. Under continuous tap water (12-21° dH) flow (2-6 l/min), the soiled swatches were rinsed until formation of stable foam was not any more visible in the rinse water.

Drying Step: The soiled swatches were removed from the rinse water and line dried in a dark closed room under ambient condition for 24 h.

The greying of the cotton and synthetic test fabrics was measured by determining the spectral reflectance at 460 nm after washing using optical geometry of D:0° on Elrepho spectrometer from Datacolor, USA.

The anti-greying properties of the detergents tested were then quantified.

Reflectance values decrease with the visible greying of the fabrics, the higher the reflectance value, the better the anti-greying performance of the detergent. Fabrics ΔR values represent the difference between the reflectance after wash of the test detergent ES1_C containing the liquid composition of the invention and the reflectance after the wash of the test detergent without the liquid composition of the invention for the
summation of 5 cotton fabrics or the 3 “synthetic” fabrics, respectively
individual fabrics

The following tables Ex2a and Ex2b include results for tested compositions:
ES1_C;
ES1_C+(a1), ES1_C+(a2), ES1_C+(b), ES1_C+(c), ES1_C+LC-I, ES1_C+LC-II, ES1_C+LC-III, ES1_C+LC-IV, ES1_C+LC-V, ES1_C+LC-VI wherein amounts of components (a1), (a2) and (c) of were 1.0% by weight each and (b) was comprised in amounts in the range of 0.006% by weight

TABLE Ex2a
greying on EMPA-SBL: greying is calculated by normalization
to ES1_C only which is set 100% greying

| ES1_C+ | cotton | synthetic |
|---|---|---|
| — | 100.0 | 100.0 |
| Component (a1) | 104.0 | 100.6 |
| Component (a2) | 111.9 | 99.2 |
| Component (b) | 50.7 | 97.8 |
| Component (c) | 96.6 | 86.6 |
| LC-I | 54.7 | 100.3 |
| LC-II | 50.6 | 99.6 |
| LC-III | 53.4 | 98.3 |
| LC-IV | 37.5 | 81.5 |
| LC-V | 39.8 | 79.3 |
| LC-VI | 39.5 | 81.3 |

TABLE Ex2b
greying on EMPA-SBL-clay: greying is calculated by normalization
to ES1_C only which is set 100% greying

| ES1_C+ | cotton | synthetic | cotton/PES |
|---|---|---|---|
| — | 100.0 | 100.0 | 100.0 |
| Component (a1) | 90.0 | 81.9 | 71.9 |
| Component (a2) | 85.1 | 81.2 | 66.3 |
| Component (b) | 66.8 | 86.7 | 53.5 |
| Component (c) | 94.2 | 95.1 | 89.3 |
| LC-I | 62.3 | 79.9 | 42.2 |
| LC-II | 58.4 | 80.4 | 38.8 |
| LC-III | 55.4 | 78.8 | 34.1 |
| LC-IV | 47.9 | 74.9 | 22.8 |
| LC-V | 51.5 | 76.3 | 27.8 |
| LC-VI | 44.2 | 74.6 | 18.9 |

1. A liquid composition comprising at least
component (a) a polymer which is
(a1) an ethoxylated hexamethylene diamine polymer, quaternized and optionally sulfated comprising on average 20 to 30 ethoxylate groups (EO) with an average molecular weight Mw in a range from 2,000 to 10,000 g/mol and mixtures thereof, and/or
(a2) an ethoxylated polyethylenimine comprising on average 15 to 25 ethoxylate groups (EO) per NH-group with an average molecular weight M_{W} in a range from 5,000 to 50,000 g/mol;
and
component (b) at least one cellulase.

2. The liquid composition according to claim 1, wherein (a1) is an ethoxylated hexamethylene diamine polymer, quaternized and sulfated comprising on average 20 to 30 ethoxylate groups (EO) with an average molecular weight Mw in a range from 5,000 to 6,000 g/mol and mixtures thereof.

3. The liquid composition according to claim 1, wherein (a2) is an ethoxylated polyethylenimine comprising on average 15 to 25 ethoxylate groups (EO) per NH-group with an average molecular weight M_{W} in a range from 12,000 to 14,000 g/mol.

4. The liquid composition according to claim 1, wherein the at least one cellulase is selected from the group consisting of endo-β-1,4-glucanases according to EC 3.2.1.4 and endo-β-1,3-glucanases according to EC 3.2.1.39.

5. The liquid composition according to claim 1, wherein the at least one cellulase is an endo-β-1,4-glucanase which has no carbohydrate binding domain (CBD).

6. The liquid composition according to claim 1, further comprising component (c), which is a copolymer of
(i) maleic acid or maleic anhydride, and
(ii) at least one hydrophobic monomer selected from the group consisting of isobutene, diisobutene, butene, and mixtures thereof,
wherein the copolymer is partially or completely neutralized.

7. The liquid composition according to claim 6, wherein the copolymer has a K-value of 35-45.

8. The liquid composition according to claim 1, further comprising at least one detergent component.

9. The liquid composition according to claim 8, wherein the liquid composition is a liquid laundry detergent.

10. The liquid composition according to claim 8, further comprising at least one anionic surfactant and at least one non-ionic surfactant.

11. A method of using the liquid composition according to claim 1, the method comprising using the liquid composition as an anti-greying additive for laundry detergents.

12. A method of using the liquid composition according to claim 8, the method comprising using the liquid composition for reducing and/or removing greying from textiles.

13. The method according to claim 12, wherein the textiles are selected from the group consisting of cotton and synthetic fabrics.

14. A method of improving anti-greying ability of a cellulase in laundry detergents, said method comprising the step of adding at least
component (a) a polymer which is
(a1) an ethoxylated hexamethylene diamine polymer, quaternized and optionally sulfated comprising on average 20 to 30 ethoxylate groups (EO) with an average molecular weight Mw in a range from 2,000 to 10,000 g/mol and mixtures thereof, and/or
(a2) an ethoxylated polyethylenimine comprising on average 15 to 25 ethoxylate groups (EO) per NH-group with an average molecular weight M_{W} in a range from 5,000 to 50,000 g/mol;
and optionally component (c) comprising at least one copolymer, wherein the copolymer is made of two types of monomers, one monomer selected from the group consisting of unsaturated carboxylic acids and one hydrophobic monomer.

15. A method for reducing and/or removing greying from laundry, said method comprising contacting the laundry with a laundry detergent comprising at least component (a) a polymer which is
(a1) an ethoxylated hexamethylene diamine polymer, quaternized and optionally sulfated comprising on average 20 to 30 ethoxylate groups (EO) with an average molecular weight Mw in a range from 2,000 to 10,000 g/mol and mixtures thereof, and/or
(a2) an ethoxylated polyethylenimine comprising on average 15 to 25 ethoxylate groups (EO) per NH-group with an average molecular weight M_{W} in a range from 5,000 to 50,000 g/mol;
and
component (b) a cellulase.

16. The liquid composition according to claim 8, wherein the liquid composition is a liquid laundry detergent comprising at least one additional enzyme.

17. The liquid composition according to claim 8, wherein the liquid composition is a liquid laundry detergent comprising at least one additional enzyme selected from the group consisting of serine endopeptidase, triacylglycerol lipase, alpha-amylase and endo-1,4-β-mannosidase.

18. The liquid composition according to claim 9, further comprising at least one anionic surfactant and at least one non-ionic surfactant.

19. A method of using the liquid composition according to claim 9, the method comprising using the liquid composition for reducing and/or removing greying from textiles.

20. A method of using the liquid composition according to claim 10, the method comprising using the liquid composition for reducing and/or removing greying from textiles.
